(19) United States
(12) Patent Application Publication
(10) Pub. No.: US 2004/0181449 A1
(43) Pub. Date: Sep. 16, 2004

(54) Award indicating device

(75) Inventor: Mark Andrew Smith, London (GB)

Correspondence Address: Michael J. Ram, KOPPEL, JACOBS, PATRICK & HEYBL, Suite 107, 555 St. Charles Drive, Thousand Oaks, CA, 91360, US

(73) Assignee: GAMESMAN LIMITED

(21) Appl. No.: 10/776,482

(22) Filed: Feb. 10, 2004

(30) Foreign Application Priority Data
Feb. 13, 2003 (GB) 0303256.2

(51) Int. Cl. G06F 17/60

(52) U.S. Cl. 705/14

(57) ABSTRACT

An award indicating device for use at a point of sale location having point of sale equipment, wherein the device comprises an automatic selector whose actuation, via an actuating device, is associated with the point of sale equipment, and wherein the selector is operable for selecting an outcome from a range of outcomes wherein at least one outcome corresponds to the indication of an available award.

This invention relates to an award indicating device for use in sales and marketing promotions.

It is known to promote the sale of products by making available gifts on a selection basis. This may involve a scratch card or other award indicating device by means of which the availability and identity of a pre-selected gift is revealed to the customer after purchase of the product e.g. by removing covering material from the scratch card or opening the product packaging to reveal gift information or the like.

The object of the present invention is to provide an award indicating device of enhanced interest to the customer.

According to the present invention there is provided an award indicating device for use at a point of sale location having point of sale equipment, said device comprising an automatic selector which is operable, when actuated, to select an outcome from a range of outcomes at least one of which corresponds to the indication of an available award, said device being mountable at said point of sale location, and an actuating device being provided which is operable to effect actuation of the said selector in association with the said point of sale equipment.

With this arrangement the availability of an award is determined by operation of the automatic selector and thereby the customer can derive enhanced interest.

The point of sale location may comprise a counter or any other suitable customer interface structure within a bar or shop or any other suitable sale premises.

The point of sale equipment may be a till, vending machine or any other device used in connection with a sales transaction capable of accepting or processing cash or a monetary equivalent such as tokens or a credit card, or product dispensing or processing equipment such as a beer pump, used in connection with product sales.

Preferably, the selector is operable by the customer and may comprise a user operable switch and a display device associated therewith.

The user operable switch may be a rocker-switch, a lever or the like but is preferably a push button.

The display, device may be any suitable device preferably comprising a selection device and a display feature said display feature having symbols each of which correspond to an outcome, the said selection device being operable to effect indication or display of a selected said symbol.

The selection device may comprise a moveable element such as a pointer, disc or reel.

Alternatively, the selection device may be an illumination device comprising a plurality of selectively illuminable LEDs or other light sources. The light sources may be illuminable in sequence, progression along the sequence terminating so that the last illuminated light source indicates the selected symbol. Other arrangements involving moving or changeable illumination patterns are also possible.

The display feature may comprise symbol bearing regions on the selection device, or located in predetermined relationships to (e.g. alongside) the selection device.

The selection device may operate in conjunction with the display feature such that at least one symbol can be selected by moving the display feature with the selection device relative to an indicator such as a fixed pointer or ‘win line’ or the like, and then arresting the selection device in a stopping position, so that the or each selected symbol is aligned with, or otherwise in predetermined disposition relative to the indicator.

Alternatively, the selection device may be movable relative to the display feature in order that at least one symbol can be selected by moving the selection device and then arresting the selection device in a stopping position in which it indicates, e.g. by pointing at or illuminating the (or each) selected symbol.

The selection device and the display feature may be arrested on a random (or pseudo-random), or predetermined basis.

With regard to the outcomes these may be any suitable kind and may be awards or other benefits, or the outcome may be no award or benefit at all.

With regard to the said outcome-indicating symbols, these may comprise words or pictures identifying the award and/or general features indicating and award category. In the latter respect the said display regions may be illuminated in different colours wherein each colour represents a different kind of outcome, for example a red light may indicate a negative outcome whereas a green light may indicate a positive outcome. The display regions may also be generally back illuminated.

In a particularly preferred embodiment, the selector comprises a push button user operable switch the details of which are described in GB 2 350 722 A The said switch is located within a bezel, said bezel housing the selection device which comprises a plurality of selectively illuminable LEDs. The selection device is surrounded by the display feature which is divided into symbol-bearing regions wherein each region corresponds to a respective LED. The LEDs of the selection device are selectively illuminated until they are arrested in a stopping position, e.g. in sequence simulating rotation, and once arrested the region corresponding to the illuminated LED indicates the outcome.

It is not necessary that the user operable switch and the display device are united in the same location. Instead the user operable switch may be remotely located relative to the display device.

The automatic selector may be mountable next to the point of sale equipment such that the selector is secure yet can be easily removed without causing damage once the promotion is over. For example, where the promotion relates to drinks, the device may be mounted on a bar. Alternatively, the said device may be mountable at a remote location relative to the point of sale equipment, for example as part of a promotion display.

The award selector may be controlled by a microprocessor control unit which may be incorporated in the selector or may be located elsewhere.

The said actuating device may operate on a random (or pseudo-random), or predetermined basis, or it may be vendor operated by way of a switch, a lever, a push button or any other suitable device. In any case, the operation of the actuating device is associated with the point of sale equipment so that it operates in correspondence with sales, i.e. whenever at least some kind of sale has occurred, or under the control of authorised sales personnel, or the like.

The actuating device may be linked to the point of sale equipment so that such equipment causes the actuating device to be operable when the point of sale equipment is used for a sale or otherwise is in an appropriate predetermined condition.

The selector may be located within a protective housing before being mounted at a point of sale location. Preferably the housing will allow the display feature to be readily changed in order that the possible outcomes can vary from product to product or even from occasion to occasion Suitable means include a slot which allows a new display feature to be inserted into place.

The said housing may be such that more than one display feature may be inserted at any one time, for example alternative display features may be stored within the housing behind the particular display feature which is currently in use.

It is envisaged that the invention will find application in the context of product promotion and in particular drinks promotion in pubs and clubs However, the invention is not restricted to this and the award indicating device may be used for any suitable purpose in any suitable context.

The invention will now be described further by way of example only and with reference to the following drawings in which:—

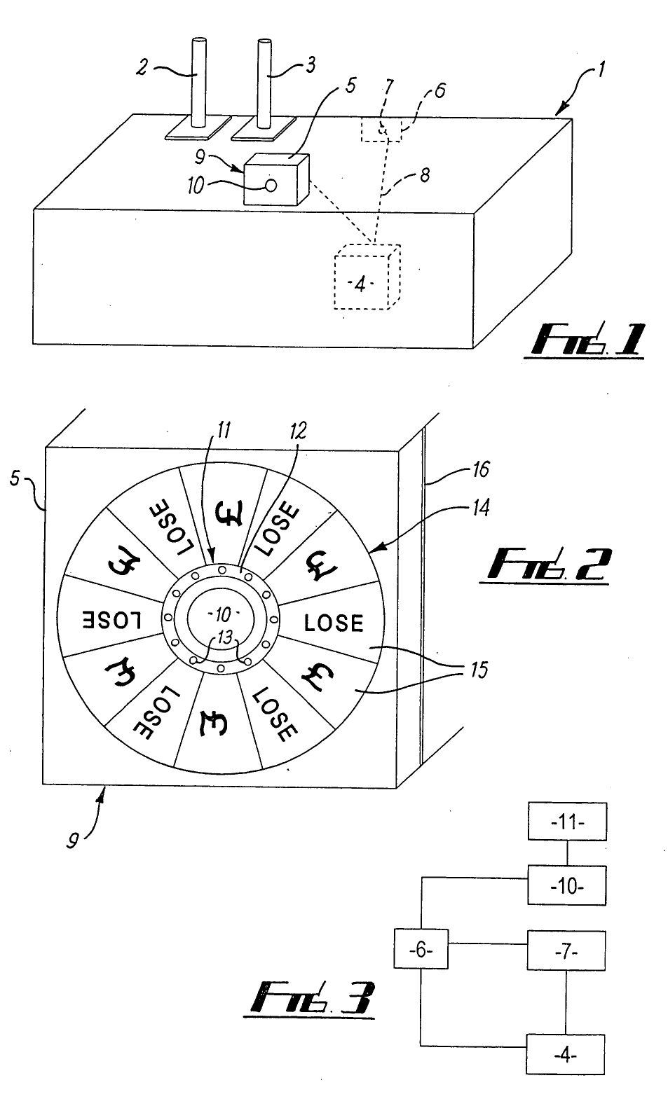

FIG. 1 is a perspective view of a bar counter upon which one form of an award indicating device according to the invention is mounted;

FIG. 2 is a front view of an automatic selector of the award indicating device; and

FIG. 3 is a block circuit diagram of the operating system of the award indicating device.

Referring to the drawings, FIG. 1 shows a bar counter 1 having located thereon point of sale equipment comprising beer pumps 2 and 3 used to dispense purchased beer. An award indicating device is installed in association with the point of sale equipment and comprises a microprocessor-based control unit 4 located underneath the counter 1 out of view of customers, an actuation device 6, and an award selector 5. The actuation device 6 comprises a push button 7 which is located within easy reach of the vendor at a location close to the pumps yet out of reach of customers. The control unit 4 is connected to the selector 5 of the award indicting device by way of concealed cables 8 and is located on the counter 1. The selector 5 comprises a push button 10 and a display feature 14 which are contained within a protective housing unit 9.

The selector 5, as shown in FIG. 2, comprises a push button 10, a selection device 11 and a display feature 14. The selection device 11 comprises a bezel 12 in which the push button 10 is positioned. Located within the bezel 12 is a plurality of LEDs 13. Display feature 14, which comprises an annular artwork display support, divided into symbol-bearing regions 15, is positioned behind the push button 10 and bezel 12 such that each of the said regions 15 corresponds to a respective LED. Located within one of the vertical housing walls is a slot 16 which facilitates the changing of the support 14

Each region 15 is marked e.g. printed with a symbol, such as wording, a picture, a colour or the like which indicated whether or not an award is to be made and if so as to the value or nature of the award.

In operation, following a sale the vendor can activate the push button 7 of the actuation device 6, which is connected to the microprocessor based control unit 4. This feeds a signal to the control unit 4 so as to activate the selector 5.

Alternatively the point of sale equipment may be connected to the control unit 4 such that when a sale of the relevant product is registered the actuation device is automatically activated, which in turn activates the selector 5 via the control unit 4.

Once the selector 5 has been activated the customer can operate the push button 10 resulting in the rapid illumination of the LEDs 13. This may be signalled to the customer by flashing of lights on the selector 5 or otherwise. The LEDs 13 may be illuminated one at a time or more than one at a time, in particular they may be illuminated in sequence simulating rotation. After a predetermined length of time the illumination of the LEDs 13 stops and just one LED remains illuminated indicating the (if any) award selected. The stopping of the illumination of the LEDs may be effected under the control of the unit 4 or any desired random pseudo-random or predetermined basis.

Alternatively, the customer may influence the stopping position of the said LEDs by pressing the push button 10 for a second time, or releasing the button, in order to arrest the selective illumination of the LEDs.

Once an outcome has been determined the selector 5 becomes inoperable until it is activated again by the actuation device 6. There may also be a time-out feature whereby the selector 5 becomes inoperable if not actuated within a predetermined time.

It is of course to be understood that the invention is not intended to be restricted to the details of the above embodiment which is described by way of example only.

1. An award indicating device for use at a point of sale location having point of sale equipment, said device comprising an automatic selector which is operable, when actuated, to select an outcome from a range of outcomes at least one of which corresponds to the indication of an available award, said device being mountable at said point of sale location, and an actuating device being provided which is operable to effect actuation of the said selector in association with the said point of sale equipment.

2. An award indicating device according to claim 1, wherein the selector comprises an operable switch and a display device associated therewith.

3. An award indicating device according to claim 2, wherein the operable switch is remotely located relative to the display device.

4. An award indicating device according to claim 3, wherein the operable switch is a rocker-switch or a lever.

5. An award indicating device according to claim 3, wherein the operable switch is a push button.

6. An award indicating device according to claim 2, wherein the display device comprises a selection device and a display feature.

7. An award indicating device according to claim 6, wherein the selection device is a moveable element.

8. An award indicating device according to claim 7, wherein the moveable element is a pointer, a disc or a reel.

9. An award indicating device according to claim 6, wherein the selection device is an illuminating device comprising a plurality of selectively illuminable light sources.

10. An award indicating device according to claim 9, wherein the light sources are LED's.

11. An award indicating device according to claim 6, wherein the selection device operates in conjunction with the display feature.

12. An award indicating device according to claim 6, wherein the selection device is moveable relative to the display feature.

13. An award indicating device according to claim 6, wherein the display feature comprises symbol bearing regions on the selection device.

14. An award indicating device according to claim 1 wherein the award selector is controlled by a microprocessor control unit.

15. An award indicating device according to claim 1, wherein the actuating device operates on a random (or pseudo-random), or predetermined basis.

16. An award indicating device according to claim 1, wherein the actuating device is vendor operated.

17. An award indicating device according to claim 1, wherein the selector is located within a protective housing.

18. An award indicating device according to claim 17, wherein the housing comprises a slot for allowing the display feature to be readily changed.
